(19) United States
(12) Patent Application Publication
(10) Pub. No.: US 2025/0208994 A1
(43) Pub. Date: Jun. 26, 2025

(54) PERFORMANCE SETTING FOR DATA PARTITIONS

(71) Applicant: Microon Technology, Inc., Boise, ID (US)

(72) Inventor: Minjian Wu, Shanghai (CN)

(21) Appl. No.: 18/970,368

(22) Filed: Dec. 5, 2024

Related U.S. Application Data
(60) Provisional application No. 63/613,328, filed on Dec. 21, 2023.

(51) Int. Cl. G06F 12/02

(52) U.S. Cl. CPC G06F 12/0246

(57) ABSTRACT

A variety of applications can include an interface for partition settings of data in a memory system. The memory system can be arranged having logical units, where each logical unit holds data of a data type different from data types in other logical units of the logical units. The memory system can include one or more buffers. An interface can be arranged in the memory system to configure a first set of the logical units to a first performance setting and configure a second set of the logical units to a second performance setting. Operation of the interface can include directing data from the first set of the logical units to the one or more buffers and include directing data from the second set of the logical units to a storage area of the memory system by bypassing the one or more buffers.

### PRIORITY APPLICATION

This application claims the benefit of priority to U.S. Provisional Application Ser. No. 63/613,328, filed Dec. 21, 2023, which is incorporated herein by reference in its entirety.

### FIELD OF THE DISCLOSURE

Embodiments of the disclosure relate generally to data storage devices, and more specifically, to memory devices and partitioning of the memory devices.

### BACKGROUND

Memory devices are typically provided as internal, semiconductor, integrated circuits in computers, multi-functional systems, and other electronic devices. There are many different types of memory, including volatile and non-volatile memory. Volatile memory requires power to maintain its data, and includes random-access memory (RAM), dynamic random-access memory (DRAM), static RAM (SRAM), or synchronous dynamic random-access memory (SDRAM), among others. Non-volatile memory can retain stored data when not powered and includes flash memory, read-only memory (ROM), electrically erasable programmable ROM (EEPROM), erasable programmable ROM (EPROM), resistance-variable memory, such as phase-change random-access memory (PCRAM), resistive random-access memory (RRAM), magnetoresistive random-access memory (MRAM), or three-dimensional (3D) XPoint™ memory, among others.

Advances in data processing and delivery of electronic content has led to systems having desired capabilities that make the systems increasingly more complicated to integrate functions of the desired capabilities. For example, in-vehicle infotainment (IVI) systems are becoming more complex as design of such systems trend towards integration of numerous functions. Enhancements to the design and operation of multi-function systems can be attained by advancements in the arrangement and control of features of memory devices used for the multi-function systems.

### BRIEF DESCRIPTION OF THE DRAWINGS

The drawings, which are not necessarily drawn to scale, illustrate generally, by way of example, but not by way of limitation, various embodiments discussed in the present document.

FIG. 1 illustrates an example of an environment including a host and a memory system configured to communicate over a communication interface, where the memory system can be implemented with a data interface implementing multiple attributes for different partition settings in memory system, in accordance with various embodiments.

FIG. 2 illustrates an example arrangement of structures operating under control of an interface to partition data in a memory system, in accordance with various embodiments.

FIG. 3 is a flow diagram of an example method of operating a memory device having data partitions, in accordance with various embodiments.

FIG. 4 is a block diagram of an example system including a host that operates with a memory system, where the memory system can partition data based on performance settings, in accordance with various embodiments.

### DETAILED DESCRIPTION

The following detailed description refers to the accompanying drawings that show, by way of illustration, various embodiments that can be implemented. These embodiments are described in sufficient detail to enable those of ordinary skill in the art to practice these and other embodiments. Other embodiments can be utilized, and structural, logical, mechanical, and electrical changes can be made to these embodiments. The various embodiments are not necessarily mutually exclusive, as some embodiments can be combined with one or more other embodiments to form new embodiments. The following detailed description is, therefore, not to be taken in a limiting sense.

Flash memory is utilized as non-volatile memory for a wide range of electronic applications. Flash memory devices typically include one or more groups of one-transistor, floating gate or charge trap memory cells that allow for high memory densities, high reliability, and low power consumption. Two common types of flash memory array architectures include negative-and (NAND) and negative-or (NOR) architectures, named after the logic form in which the basic memory cell configuration of each is arranged.

Each flash memory cell in a NOR or NAND architecture semiconductor memory array can be programmed individually or collectively to one or a number of programmed states. For example, a single-level cell (SLC) can represent one of two programmed states (for example 1 or 0), representing one bit of data. However, flash memory cells can also represent one of more than two programmed states, allowing the manufacture of higher density memories without increasing the number of memory cells, as each cell can represent more than one binary digit (for example more than one bit). Such cells can be referred to as multi-state memory cells, multi-digit cells, or multi-level cells (MLCs). MLC is used herein in its broader context to refer to any memory cell that can store more than one bit of data per cell, that is, can represent more than two programmed states. A dual-level cell is a memory cell that can store two bits of data per cell, which is one of four programmed states. A triple-level cell (TLC) refers to a memory cell that can store three bits of data per cell, which is one of eight programmed states. A quad-level cell (QLC) stores four bits of data per cell, which is one of sixteen programmed states. DLC, TLC, and QLC are examples of MLCs.

Memory arrays or devices can be combined together to form a storage volume of a memory system. Storage devices can include, among others, an embedded MultiMediaCard (eMMC™) device, a Universal Flash Storage (UFS™) device, or a solid-state drive (SSD). The memory system can be, but is not limited to, a managed memory system. In general, a managed memory system can be realized as a combination of one or more individual flash memory devices combined with a hardware controller that performs management features for the one or more flash memories. The flash memories can be NAND memory devices. SSD, UFS, and eMMC devices can be managed NAND memory systems that include processing circuitry such as memory controllers, direct memory access (DMA) controllers, and flash memory interface circuitry to manage the access to physical memory. A managed NAND memory system may also include DRAM, SRAM, other forms of memory die, or other memory structures.

A managed memory system, which can be, but is not limited to, a managed NAND memory system, can include multiple logical units (LUNs) to hold data. The LUNS can be arranged as independently configured data storing units for a data type specific to the independently configured LUN. The multiple LUNs can be groups of memory locations distributed among one or more memory devices of the managed memory system. The multiple LUNs can be structured in a number of memory dies of the managed memory system.

As IVI systems integrate numerous functions such as, but not limited to, over-the-air (OTA) functions, data video recorder (DVR) functions, navigation functions, and other functions, IVI systems become more complicated. In addition, the applications of storage devices are also becoming complicated, for example with respect to storage of data of many different data types. The different data types can include, but are not limited to, boot data, operating system (OS) image data, map data, DVR video data, and other types of data.

For different partitions of data of different data types, the write data sizes can have significantly different data sizes. For example, a write data size for a DVR partition for video cyclic buffer can normally be very large, while the write data size for a boot partition can be limited.

Another data performance parameter, complicated by the integration of numerous functions, is burst writes. The burst performances for different partitions of data types can be quite different. For an OS data region, a map data region, and an application data region, most of the operations on these regions are read operations, with a few write operations from time to time. Associated with these write operations on these regions are write latencies, which are important for user experiences.

Sometimes, a system can undergo an upgrade through OTA operations, where an OTA size can include several GBs, for example 2 GB. Such a system can normally request to download the image as soon as possible from a cloud to avoid impact on user experiences. Typically, the term “cloud” with respect to data processing and communicating refers to a datacenter full of servers that is connected to the Internet. However, cloud may refer to any network or combinations of networks. A cloud can include a wide area network (WAN) like the public Internet or a private, national or global network, and may include a local area network (LAN) within an organization providing the services of the datacenter.

To avoid the impact on user experiences, the burst write performance for OTA image download is an important parameter for an application, where the burst write performance can be, for example, greater than 200 MB/s. For DVR application, the data writes are continuous, and the write performance is typically not large, for example, in the range of approximately 2 MB/s to approximately 4 MB/s. However, endurance is an important parameter for a DVR application.

In various embodiments, an interface can be defined to provide an enhanced storage solution for mixed applications in a memory system. The enhanced storage can lead to an optimization of storage solution for the mixed applications. Such an interface can be implemented in systems similar to IVI systems and DVR systems. Multiple attributes can be defined for different partition settings in the memory system. Users of the memory system can select an optimal setting according to the application of the memory system by the user.

One attribute that can be defined for a partition setting can be a lifetime setting. When there are a large number of write operations, endurance, viewed as lifetime, can be an important performance parameter. With a lifetime setting, the lifetime of a given partition can be enhanced tending to an optimized lifetime for the given partition. A second attribute that can be defined for another partition setting can be a burst writing setting. With a few write operations from time to time on a partition, impact of endurance is not key for the second attribute, where the important factor is to meet expectations of write latency for fast response of applications that can lead to optimized burst writing.

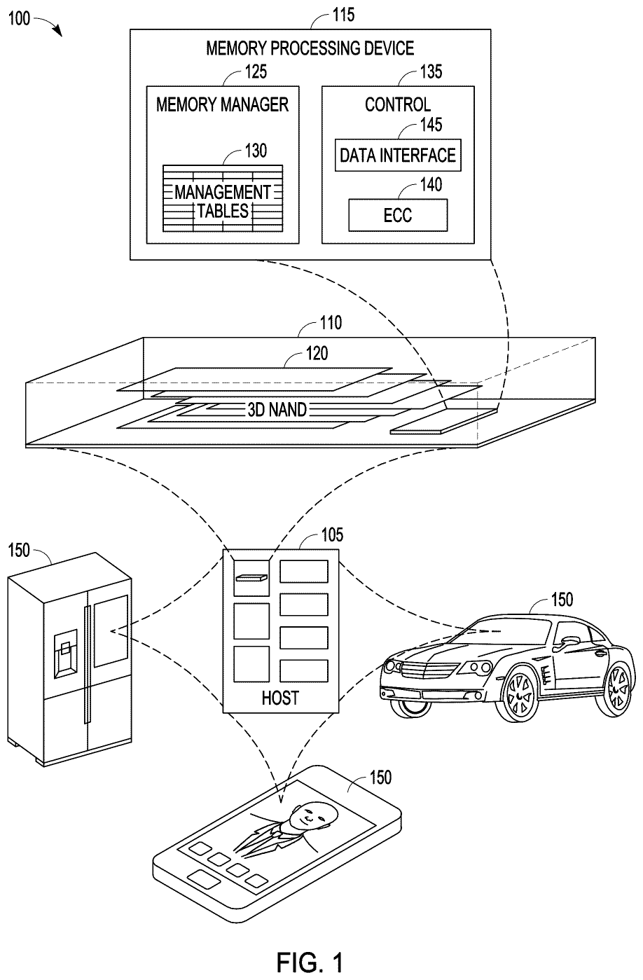

FIG. 1 illustrates an example of an environment 100 including a host 105 and a memory system 110 configured to communicate over a communication interface, where memory system 110 can be implemented with a data interface implementing multiple attributes for different partition settings in memory system 110. Host 105 can be implemented as one or more systems or one or more devices. Host 105 or memory system 110 may be included in a variety of products 150, such as Internet of Things (IoT) systems to support processing, communications, or control of the product 150. The IoT systems can include, but are not limited to, refrigerators or other appliances, sensors, motors or actuators, mobile communication devices, automobiles, drones, and other electronic systems. These IoT systems can include IVI systems.

Memory system 110 includes a memory processing device 115 and a memory array 120 including, for example, a number of individual memory die, for example, a stack of three-dimensional (3D) NAND die. In 3D architecture semiconductor memory technology, vertical structures are stacked, increasing the number of tiers, physical pages, and accordingly, the density of a memory device. In an example, memory system 110 can be a discrete memory or storage device component of host 105. In other examples, memory system 110 can be a portion of an integrated circuit, such as but not limited to a system on a chip (SOC), stacked or otherwise included with one or more other components of host 105.

One or more communication interfaces can be used to transfer data between memory system 110 and one or more other components of host 105. The one or more communication interfaces can include one or more of a Serial Advanced Technology Attachment (SATA) interface, a Peripheral Component Interconnect Express (PCIe) interface, a Universal Serial Bus (USB) interface, a Universal Flash Storage (UFS) interface, an eMMC™ interface, an OTA interface, or one or more other connectors or interfaces. Host 105 can include a host system, an electronic device, a processor, a memory card reader, or one or more other electronic devices external to memory system 110.

Memory processing device 115 can receive instructions from host 105, and can communicate with memory array 120, such as to transfer data to (e.g., write or erase) or from (e.g., read) one or more of the memory cells, planes, sub-blocks, blocks, or pages of the memory array. Memory processing device 115 can include, among other things, circuitry or firmware, including one or more components or integrated circuits. For example, memory processing device 115 can include one or more memory control units, circuits, or components configured to control access across memory array 120 and to provide a translation layer between host 105 and memory system 110. Memory processing device 115 can include one or more input/output (I/O) circuits, lines, or interfaces to transfer data to or from memory array 120. Memory processing device 115 can include a memory manager 125 and an controller 135, where controller 135 can control memory array 120.

Memory manager 125 can include, among other things, circuitry or firmware, such as a number of components or integrated circuits associated with various memory management functions. For purposes of the present description example memory operation and management functions will be described in the context of NAND memory. Persons skilled in the art will recognize that other forms of non-volatile memory may have analogous memory operations or management functions. Such NAND management functions include wear leveling (e.g., garbage collection or reclamation), error detection or correction, block retirement, or one or more other memory management functions. Memory manager 125 can parse or format host commands received from host 105 into device commands, which include commands associated with operation of memory array 120, or generate device commands to accomplish various memory management functions for controller 135 or one or more other components of memory system 110.

Memory manager 125 can include a set of management tables 130 configured to maintain various information associated with one or more components of memory system 110. The information can include various information associated with a memory array or one or more memory cells coupled to memory processing device 115. For example, management tables 130 can include information regarding block age, block erase count, error history, or one or more error counts for one or more blocks of memory cells coupled to memory processing device 115. The error counts can include a write operation error count, a read bit error count, a read operation error count, an erase error count, and other similar counts. In certain examples, if the number of detected errors for one or more of the error counts is above a threshold, the bit error can be referred to as an uncorrectable bit error. Management tables 130 can maintain a count of correctable or uncorrectable bit errors, among other things.

Controller 135 can include, among other things, circuitry or components configured to control memory operations associated with writing data to, reading data from, or erasing one or more memory cells of memory system 110 coupled to memory processing device 115. The memory operations can be based on, for example, host commands received from host 105, or internally generated by memory manager 125. The internally generated operations can be associated with wear leveling, error detection or correction, or other similar operations.

Controller 135 can include an error correction code (ECC) component 140, which can include, among other things, an ECC engine or other circuitry configured to detect or correct errors associated with writing data to or reading data from one or more memory cells of memory system 110 coupled to memory processing device 115. Memory processing device 115 can be configured to actively detect and recover from error occurrences (e.g., bit errors, operation errors, etc.) associated with various operations or storage of data, while maintaining integrity of the data transferred between host 105 and memory system 110, or maintaining integrity of stored data, for example, using redundant RAID storage or other functionally similar structure, and can remove failing memory resources to prevent future errors.

Memory array 120 can include several memory cells arranged in, for example, a number of devices, planes, sub-blocks, blocks, or pages. As one example, a 48 GB TLC NAND memory device can include 18,592 bytes (B) of data per page (16,384+2208 bytes), 1536 pages per block, 548 blocks per plane, and 4 or more planes per device. As another example, a 32 GB DLC memory device, storing two bits of data per cell for four programmable states, can include 18,592 bytes (B) of data per page (16,384+2208 bytes), 1024 pages per block, 548 blocks per plane, and 4 planes per device, but with half the required write time and twice the program/erase (P/E) cycles as a corresponding TLC memory device. Other examples can include other numbers or arrangements. In some examples, a memory device, or a portion thereof, may be selectively operated in SLC mode, or in a desired MLC mode such as DLC, TLC, QLC, or other mode of data.

In operation, data is typically written to or read from memory system 110, as a NAND memory system, in pages, and erased in blocks. However, one or more memory operations (e.g., read, write, erase, etc.) can be performed on larger or smaller groups of memory cells, as desired. The data transfer size of memory system 110, as a NAND memory system, is typically referred to as a page; whereas the data transfer size of a host is typically referred to as a sector.

Different data types of memory cells or memory arrays 120 can provide for different page sizes, or may require different amounts of metadata associated therewith. For example, different memory device types may have different bit error rates, which can lead to different amounts of metadata necessary to ensure integrity of the page of data. For example, a memory device with a higher bit error rate may require more bytes of error correction code data than a memory device with a lower bit error rate. As an example, a MLC NAND flash device may have a higher bit error rate than a corresponding SLC NAND flash device. As such, the MLC device may require more metadata bytes for error data than the corresponding SLC device.

Memory system 110 can be structured with one or more memory devices arranged having LUNs, where each LUN is configured to hold data of a data type different from data types in other LUNs. Memory processing device 115 along with firmware can define an interface 145 arranged to configure a set of the LUNs to a performance setting and configure another set of the LUNs to another performance setting. Memory processing device 115 along with firmware can direct data to one or more buffers of memory system 110 based on one of the performance setting from the first set of the logical units to the one or more buffers and direct other data to a storage area of memory system 110 bypassing the one or more buffers, based on another performance setting. The storage area can have a MLC mode of data storage, where the MLC mode is a higher level storage mode than the data storage mode of the one or more buffers. Users of memory system 110 can select an optimal setting according to the application of memory system 110 by the user.

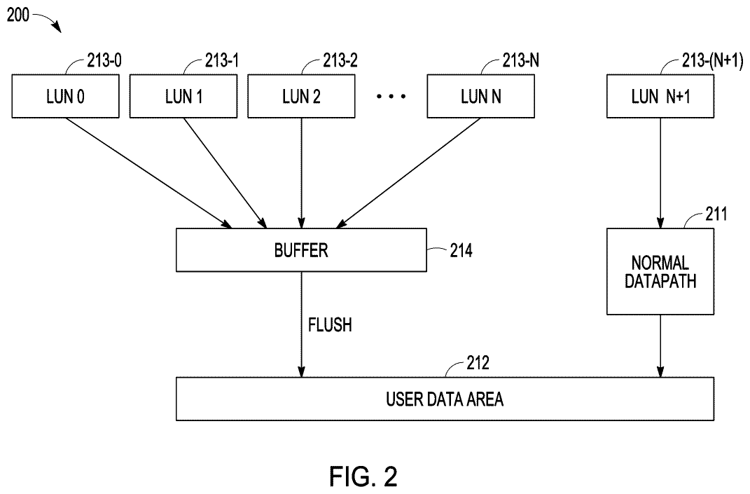

FIG. 2 illustrates an embodiment of an example arrangement 200 of structures operating under control of an interface to partition data in a memory system. The memory system can include one or more memory devices arranged having sets of LUNs and a user data area 212. A first set of LUNs can include LUN 213-0, LUN 213-1, LUN 213-2 . . . LUN-N and a second set of LUNs can include LUN 213-(N+1). The memory devices can be implemented as a selected set of storage media. Though two sets of LUNs are shown, arrangement 200 or similar arrangement can include more than two sets of LUNs. The controlling interface can be implemented by one or more processors and stored instructions for data partitioning, where the stored instructions can be located in a portion of the one or more memory devices, within the one or more processors, or in a storage device of the memory system separate from the one or more processors and separate from the one or more memory devices. The stored instructions can be executed in operation of firmware for the memory system. Alternatively, the interface can be implemented by circuitry to partition data in the memory system based identification of data types.

Firmware of a memory system can be implemented as microcode embedded in hardware embedded in one or more hardware devices of the memory system to assist in operation of the memory system. Firmware can include executable instructions that can be used in hardware start up, in communication with other devices, maintain the operating health of the hardware devices of the memory system, and perform basic input/output tasks for the memory system, among other tasks. Firmware can be arranged to execute dedicated tasks for the memory system, which are independent or semi-independent of other tasks of the firmware.

The two sets of LUNs can be configured according to two different attributes. The first set having LUN 213-0, LUN 213-1, LUN 213-2 . . . LUN-N can be partitioned with data of data types for a burst write performance attribute. One or more of LUN 213-0, LUN 213-1, LUN 213-2 . . . LUN-N can be independently configured to the burst write setting for enhanced data control. Such enhancement may be considered as configuring such LUNs to an “optimal burst write setting.” For the burst write setting, data can be directed from the LUNs of the first set, configured to the burst write setting, to a buffer 214. The data in buffer 214 can be flushed from buffer 214 to user data area 212. Buffer 214 can be structured as one or more buffers shared by the LUNs of the first set configured to the burst write setting. Data flushing to a memory is storing the data in the memory.

User data area 212 can be a memory region having a data storage mode greater than the data storage mode of buffer 214. For example, buffer 214 can have a data storage mode of SLC and user data area 121 can have a data storage mode of TLC. With user data area 212 being at least a portion of a NAND memory device, user data area 212 can be referred to as a TLC NAND area and buffer 214 can be referred to as a SLC buffer. Other data storage modes can be used for the data storage mode of buffer 214 being at a level less than the level of the data storage mode of user data area 212. In an example instance, LUN 213-0, LUN 213-1, LUN 213-2 . . . LUN-N can be partitioned to hold data of boot data type, OS data type, map data type, speech data type, application data type, and OTA data types, respectively. Normally, the LUNs with these data types have write burst performance different from data types like DVR data types, which can be set to a lifetime setting.

With data being transferred from low mode of data storage of buffer 214 to a higher mode of data storage of user data area 212, the stored data is translated from one bit format to a higher bit format. For example, the data format of SLC buffer 214 is changed to the data format of user data area 212. This translation is referred to as data folding. Due to folding, such as SLC to TLC folding, a write application factor can be much larger than for a direct transfer from a LUN to user data area 212. Write amplification is a condition associated with memory systems, such as flash memories and solid-state drives, in which the actual amount of information physically written to the storage media of the memory system is a multiple of the logical amount intended to be written by a host device interfacing with the memory system.

The second set, having LUN 213-(N+1), can be partitioned with data of data types for a lifetime performance attribute. Lifetime performance attribute is related to endurance of data in a LUN used for a significant number of write operations. Though the second set of arrangement 200 shows one LUN, this set can also include multiple LUNs. LUN 213-(N+1), like other LUNs of this second set, can be independently configured to the lifetime performance setting also for enhanced data control. Such enhancement may be considered as configuring such LUNs to an “optimal lifetime setting.” For the lifetime performance setting, data is directed to user data area 212 via a normal data path 211. A normal data path 211 can include one or more structures that are normally used to store user data in storage media of a memory system, such as but not limited to, a NAND memory device of a managed NAND memory system.

With the data storage mode of LUN 213-(N+1) being the same as the data storage mode of user data area 212, data, which is transferred form LUN 213-(N+1) to user data area 212, can have a write amplify factor lower than that of each of LUN 213-0, LUN 213-1, LUN 213-2 . . . LUN-N. The common data storage mode can be, but is not limited to, TLC. The lower write amplify factor of the second set of LUNs of arrangement 200 can provide better lifetime performance than the first set of LUNs. The lifetime performance setting is appropriate for data having a DVR data type that can be partitioned into LUN-(N+1).

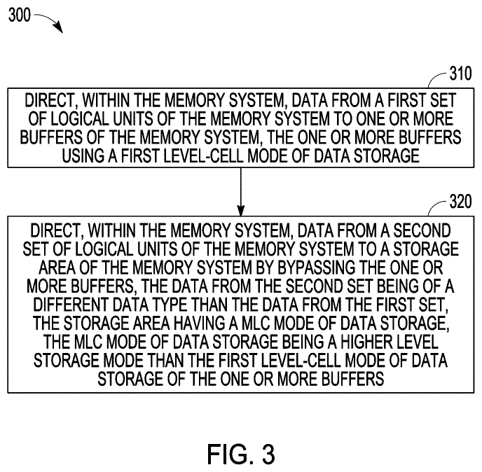

FIG. 3 is a flow diagram of an embodiment of an example method of operating a memory device having data partitions. At 310, data is directed, within the memory system, from a first set of LUNs of the memory system to one or more buffers of the memory system. The one or more buffers can hold the data using a first level-cell mode of data storage. The mode of data storage of the one or more buffers can be fixed to a particular level of data storage according to operational parameters of the one or more buffers. At 320, data is directed, within the memory system, from a second set of LUNs of the memory system to a storage area of the memory system by bypassing the one or more buffers, where the data from the second set is a different data type than the data from the first set. The storage area has a MLC mode of data storage and the MLC mode of data storage is a higher level storage mode than the first level-cell mode of data storage of the one or more buffers.

Variations of method 300 or methods similar to method 300 can include a number of different embodiments that may be combined depending on the application of such methods and/or the architecture of systems including a memory system for which such methods are implemented. Variations can include partitioning one or more memory devices of the memory system to include multiple sets of LUNs, where each LUN is configured to hold data of a data type different from data types in other LUNs of the partitioned LUNs. Variations can include configuring the first set of LUNs to a first performance setting and configuring the second set of LUNs to a second performance setting.

Variations of method 300 or methods similar to method 300 can include flushing data in the one or more buffers to the storage area. The first level-cell mode of data storage of at least one of the buffers can be a SLC mode of data storage and the MLC mode of data storage can be a TLC mode of data storage.

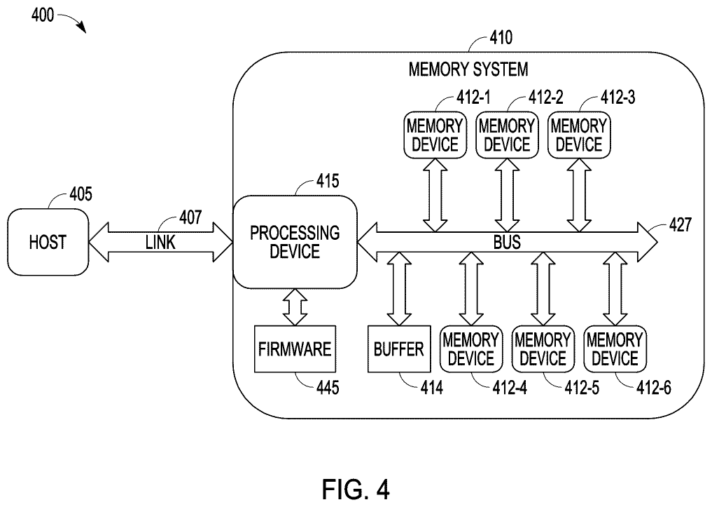

FIG. 4 is a block diagram of an embodiment of example system including a host 405 that operates with a memory system 410, where memory system 410 can partition data based on performance settings. Memory system 410 can be implemented in a variety of electronic systems. For example, memory system 420 can be structured in an IVI system. The IVI system can be designed for use in an automobile.

Host 405 can be coupled to memory system 410 by a link 407. Memory system 410 can include a processing device 415 coupled to memory devices 412-1, 412-2, 412-3, 412-4, 412-5, and 412-6 by a bus 427. Memory devices 412-1, 412-2, 412-3, 412-4, 412-5, and 412-6 may be NAND memory devices. Though six memory devices are shown in FIG. 4, memory system 410 can be implemented with less or more than six memory devices, that is memory system 410 can comprise one or more memory devices. The memory devices can be realized in a number of formats including, but not limited to, a plurality of memory dies. The one or more memory devices can include sets of LUNs arranged based on performance settings of data types held in the LUNs. The one or more memory devices can include user data regions having different data storage modes. For example, the one or more memory devices can include SLC regions and TLC regions. Processing device 415 can include or be structured as one or more processors.

Memory system 400 can comprise firmware 445 having code executable by processing device 415 to at least manage memory devices 412-1, 412-2, 412-3, 412-4, 412-5, and 412-6. Firmware 445 can reside in a storage device of memory system 410 coupled to processing device 415. Firmware 445 can be coupled to processing device 415 using bus 427 or some other interface on memory system 410. Alternatively, firmware 445 can reside in processing device 415 or can be distributed in memory system 410 with firmware components, such as but not limited to code, including one or more components in processing device 415. Firmware 445 can include code having instructions, executable by processing device 415, to operate on memory devices 412-1, 412-2, 412-3, 412-4, 412-5, and 412-6. The instructions can include instructions to execute transfer of data from different sets of LUNs to a user data region in one or more of memory devices 412-1, 412-2, 412-3, 412-4, 412-5, and 412-6 using different paths based on performance settings assigned to the different sets of LUNs, as taught herein, where a buffer 414 is used to direct data from a specified set of LUNs to the user data region. Processing device 415 and firmware 445 can be structured to execute an interface to operate as shown in or similar to arrangement 200 of FIG. 2.

System 400 and its components can be structured in a number of different arrangements. For example, system 400 can be arranged with a variation of the type of components that comprise host 405, link 407, memory system 410, memory devices 412-1, 412-2, 412-3, 412-4, 412-5, and 412-6, processing device 415, and bus 427. Host 405 can comprise one or more processors, which can vary in type. Link 407 can be arranged as, but not limited to, a peripheral component interconnect express (PCIe) interface. Link 407 can include an OTA link. Memory system 410 can be, but is not limited to, a managed NAND memory system with memory devices 412-1, 412-2, 412-3, 412-4, 412-5, and 412-6 being NAND memory devices. Processing device 415 can include or be structured as one or more types of processors compatible with memory devices 412-1, 412-2, 412-3, 412-4, 412-5, and 412-6. Bus 427 can be an open NAND flash interface (ONFI) bus for memory devices 412-1, 412-2, 412-3, 412-4, 412-5, and 412-6 being NAND flash memory devices. Buffer 414 can be or included in a RAM. Though buffer 414 is external to processing device 415 in memory system 410 in FIG. 4, buffer 414 may be integrated into processing device 415. Buffer 414 can be coupled to bus 427 for communication with other components of memory system 410. Alternatively, buffer 414 can be coupled with processing device 415 in which processing device 415 handles communications between buffer 414 and other components of memory system 410. Buffer 414 can be coupled to bus 427 and to processing device 415.

In an example, firmware 445 or other components of memory system 410 can have instructions, executable by processing device 415, to operate on multiple memory devices of memory devices 412-1, 412-2, 412-3, 412-4, 412-5, and 412-6 to provide an interface to attain an enhanced storage solution for mixed applications in memory system 410. One or more of memory devices 412-1, 412-2, 412-3, 412-4, 412-5, and 412-6 can include multiple sets of LUNs. The instructions can be executed to perform operations to configure a first set of the logical units to a first performance setting and to configure a second set of the logical units to a second performance setting. The instructions can be executed to perform operations to direct data from the first set of the logical units to buffer 414, and to direct data from the second set of the logical units to a storage area of memory devices 412-1, 412-2, 412-3, 412-4, 412-5, and 412-6 by bypassing buffer 414. The storage area in one or more memory devices 412-1, 412-2, 412-3, 412-4, 412-5, and 412-6 can have a MLC mode of data storage, where the MLC mode of data storage is a higher level storage mode than the level-cell mode of data storage of buffer 414. For example, buffer 414 can have a SLC mode of data storage, and the MLC mode of data storage can be a TLC mode of data storage.

Buffer 414 can be a shared buffer for data from the LUNs of the first set. The LUNs of the first set can have the first performance setting that is a setting identifying that data is to be directed to buffer 414. The first performance setting can include identification of a burst write attribute. The first set of LUNs can have data types that include boot data, operating system data, map data, speech data, application data, and over-the-air data. The interface can be arranged to flush data in buffer 414 to the storage area in one or more memory devices 412-1, 412-2, 412-3, 412-4, 412-5, and 412-6. The LUNs of the second set can have the second performance setting that is a setting identifying that data is to be directed to the storage area in one or more memory devices 412-1, 412-2, 412-3, 412-4, 412-5, and 412-6, avoiding use of buffer 414. The second performance setting can include identification of a lifetime attribute. The second set of LUNs can include, but is not limited to, a logical unit containing data video recorder data type. Alternatively, the interface can be implemented by circuitry to partition data in memory system 410 based identification of data types, to provide an enhanced storage solution for mixed applications in a memory system.

In an example, firmware 445 or other components of memory system 410 can have instructions, executable by processing device 415, to operate on one or more of memory devices 412-1, 412-2, 412-3, 412-4, 412-5, and 412-6 with respect to multiple sets of LUNs. The instructions can be executed to perform operations, where the operations can include partitioning the one or more memory devices to have multiple sets of LUNs, where each LUN is arranged to hold data of a data type different from data types in other LUNs of the partitioned LUNs. The operations can include direction of data from a first set of the LUNs to buffer 414 based on a first attribute assigned to the first set, and direction of data from a second set of the LUNs to a storage area of one or more of memory devices 412-1, 412-2, 412-3, 412-4, 412-5, and 412-6 based on a second attribute assigned to the second set, bypassing buffer 414. The first attribute can include a burst write performance and the second attribute can include a lifetime performance.

The storage area of one or more of memory devices 412-1, 412-2, 412-3, 412-4, 412-5, and 412-6 can have a MLC mode of data storage, where the MLC mode of data storage is a higher level storage mode than that of buffer 414. For example, buffer 414 can have a SLC mode of data storage, and the MLC mode of data storage can be a TLC mode of data storage. The executed operations can include the flush of data in buffer 414 to the storage area of one or more of memory devices 412-1, 412-2, 412-3, 412-4, 412-5, and 412-6.

The following examples are example embodiments of systems and methods, in accordance with the teachings herein.

An example memory system 1 can comprise one or more memory devices arranged having LUNs, each LUN to hold data of a data type different from data types in other LUNs of the LUNs; one or more buffers structured to hold data using a first level-cell mode of data storage; an interface arranged to: configure a first set of the LUNs to a first performance setting; configure a second set of the LUNs to a second performance setting; direct data from the first set of the LUNs to the one or more buffers; direct data from the second set of the LUNs to a storage area of the memory system by bypassing the one or more buffers, the storage area having a MLC mode of data storage, the MLC mode of data storage being a higher level storage mode than the first level-cell mode of data storage of the one or more buffers.

An example memory system 2 can include features of example memory system 1 and can include the interface arranged to flush data in the one or more buffers to the storage area.

An example memory system 3 can include features of any of the preceding example memory systems and can include the one or more buffers being a shared buffer.

An example memory system 4 can include features of any of the preceding example memory systems and can include the second performance setting being a setting identifying that data is to be directed to the storage area avoiding use of the one or more buffers.

An example memory system 5 can include features of any of the preceding example memory systems and can include the first performance setting being a setting identifying that data is to be directed to the one or more buffers.

An example memory system 6 can include features of any of the preceding example memory systems and can include the first level-cell mode of data storage being a SLC mode of data storage.

An example memory system 7 can include features of any of the preceding example memory systems and can include the MLC mode of data storage being a triple-level cell TLC mode of data storage.

An example memory system 8 can include features of any of the preceding example memory systems and can include the first set of the LUNs having data types including boot data, operating system data, map data, speech data, application data, and over-the-air data.

An example memory system 9 can include features of any of the preceding example memory systems and can include the second set of the LUNs to include a LUN containing data video recorder data type.

In an example memory system 10, any of the memory systems of example memory systems 1 to 9 may include memory systems incorporated into an electronic apparatus further comprising a host processor and a communication bus extending between the host processor and the memory system.

In an example memory system 11, any of the memory systems of example memory systems 1 to 10 may be modified to include any structure presented in another of example memory system 1 to 10.

In an example memory system 12, any apparatus associated with the memory systems of example memory systems 1 to 11 may further include a machine-readable storage device configured to store instructions as a physical state, wherein the instructions may be used to perform one or more operations of the apparatus.

In an example memory system 13, any of the memory systems of example memory systems 1 to 12 may be operated in accordance with any of the below example methods 1 to 9 of operating a memory system.

An example memory system 14 can comprise one or more memory devices to receive data of different data types; one or more buffers structured to hold data using a first level-cell mode of data storage; a processing device to execute instructions, stored in the memory system, to cause the memory system to perform operations, the operations including: partitioning the one or more memory devices to include multiple sets of LUNs, each LUN to hold data of a data type different from data types in other LUNs of the partitioned LUNs; directing data from a first set of the LUNs to the one or more buffers based on a first attribute assigned to the first set; directing data from a second set of the LUNs to a storage area of the memory system based on a second attribute assigned to the second set, bypassing the one or more buffers, the storage area having a MLC mode of data storage, the MLC mode of data storage being a higher level storage mode than the first level-cell mode of data storage of the one or more buffers.

An example memory system 15 can include features of example memory system 14 and can include the operations to include flushing data in the one or more buffers to the storage area.

An example memory system 16 can include features of any of the preceding example memory systems 14 to 15 and can include the first attribute including a burst write performance and the second attribute including a lifetime performance.

An example memory system 17 can include features of any of the preceding example memory systems 14 to 16 and can include the first level-cell mode of data storage being a SLC mode of data storage.

An example memory system 18 can include features of any of the preceding example memory systems 14 to 17 and can include the MLC mode of data storage being a TLC mode of data storage.

An example memory system 19 can include features of any of the preceding example memory systems 14 to 18 and can include the memory system being structured in an in-vehicle infotainment system.

In an example memory system 20, any of the memory systems of example memory systems 14 to 19 may include memory systems incorporated into an electronic apparatus further comprising a host processor and a communication bus extending between the host processor and the memory system.

In an example memory system 21, any of the memory systems of example memory systems 14 to 20 may be modified to include any structure presented in another of example memory system 14 to 20.

In an example memory system 22, any apparatus associated with the memory systems of example memory systems 14 to 21 may further include a machine-readable storage device configured to store instructions as a physical state, wherein the instructions may be used to perform one or more operations of the apparatus.

In an example memory system 23, any of the memory systems of example memory systems 14 to 22 may be operated in accordance with any of the below example methods 1 to 9 of operating a memory system.

An example method 1 of operating a memory system can comprise directing, within the memory system, data from a first set of LUNs of the memory system to one or more buffers of the memory system, the one or more buffers using a first level-cell mode of data storage; and directing, within the memory system, data from a second set of LUNs of the memory system to a storage area of the memory system by bypassing the one or more buffers, the data from the second set being of a different data type than the data from the first set, the storage area having a MLC mode of data storage, the MLC mode of data storage being a higher level storage mode than the first level-cell mode of data storage of the one or more buffers.

An example method 2 of operating a memory system can include features of example method 1 of operating a memory system and can include partitioning one or more memory devices of the memory system to include multiple sets of LUNs, each LUN to hold data of a data type different from data types in other LUNs of the partitioned LUNs.

An example method 3 of operating a memory system can include features of any of the preceding example methods of operating a memory system and can include configuring the first set of LUNs to a first performance setting; and configuring the second set of LUNs to a second performance setting.

An example method 4 of operating a memory system can include features of any of the preceding example methods of operating a memory system and can include flushing data in the one or more buffers to the storage area.

An example method 5 of operating a memory system can include features of any of the preceding example methods of operating a memory system and can include the first level-cell mode of data storage being a SLC mode of data storage and the MLC mode of data storage being a TLC mode of data storage.

In an example method 6 of operating a memory system, any of the example methods 1 to 5 of operating a memory system may be performed in operating an electronic apparatus further comprising a host processor and a communication bus extending between the host processor and the memory system.

In an example method 7 of operating a memory system, any of the example methods 1 to 6 of operating a memory system may be modified to include operations set forth in any other of example methods 1 to 6 of operating a memory system.

In an example method 8 of operating a memory system, any of the example methods 1 to 7 of operating a memory system may be implemented at least in part through use of instructions stored as a physical state in one or more machine-readable storage devices.

An example method 9 of operating a memory system can include features of any of the preceding example methods 1 to 8 of operating a memory system and can include performing functions associated with any features of example memory systems 1 to 23.

An example machine-readable storage device storing instructions, that when executed by one or more processors, cause a machine to perform operations, can comprise instructions to perform functions associated with any features of example memory systems 1 to 23 or perform methods associated with any features of example methods 1 to 9 of operating a memory system.

Although specific embodiments have been illustrated and described herein, it will be appreciated by those of ordinary skill in the art that any arrangement that is calculated to achieve the same purpose can be substituted for the specific embodiments shown. Various embodiments use permutations and/or combinations of embodiments described herein. It is to be understood that the above description is intended to be illustrative, and not restrictive, and that the phraseology or terminology employed herein is for the purpose of description.

What is claimed is:

1. A memory system comprising:
one or more memory devices arranged having logical units, each logical unit to hold data of a data type different from data types in other logical units of the logical units;
one or more buffers structured to hold data using a first level-cell mode of data storage;
an interface arranged to:
configure a first set of the logical units to a first performance setting;
configure a second set of the logical units to a second performance setting;
direct data from the first set of the logical units to the one or more buffers;
direct data from the second set of the logical units to a storage area of the memory system by bypassing the one or more buffers, the storage area having a multi-level cell (MLC) mode of data storage, the MLC mode of data storage being a higher level storage mode than the first level-cell mode of data storage of the one or more buffers.

2. The memory system of claim 1, wherein the interface is arranged to flush data in the one or more buffers to the storage area.

3. The memory system of claim 1, wherein the one or more buffers is a shared buffer.

4. The memory system of claim 1, wherein the second performance setting is a setting identifying that data is to be directed to the storage area avoiding use of the one or more buffers.

5. The memory system of claim 1, wherein the first performance setting is a setting identifying that data is to be directed to the one or more buffers.

6. The memory system of claim 1, wherein the first level-cell mode of data storage is a single-level cell (SLC) mode of data storage.

7. The memory system of claim 1, wherein the MLC mode of data storage is a triple-level cell (TLC) mode of data storage.

8. The memory system of claim 1, wherein the first set of the logical units has data types including boot data, operating system data, map data, speech data, application data, and over-the-air data.

9. The memory system of claim 1, wherein the second set of the logical units includes a logical unit containing data video recorder data type.

10. A memory system comprising:
one or more memory devices to receive data of different data types;
one or more buffers structured to hold data using a first level-cell mode of data storage;
a processing device to execute instructions, stored in the memory system, to cause the memory system to perform operations, the operations including:
partitioning the one or more memory devices to include multiple sets of logical units, each logical unit to hold data of a data type different from data types in other logical units of the partitioned logical units;
directing data from a first set of the logical units to the one or more buffers based on a first attribute assigned to the first set;
directing data from a second set of the logical units to a storage area of the memory system based on a second attribute assigned to the second set, bypassing the one or more buffers, the storage area having a multi-level cell (MLC) mode of data storage, the MLC mode of data storage being a higher level storage mode than the first level-cell mode of data storage of the one or more buffers.

11. The memory system of claim 10, wherein the operations include flushing data in the one or more buffers to the storage area.

12. The memory system of claim 10, wherein the first attribute includes a burst write performance and the second attribute includes a lifetime performance.

13. The memory system of claim 10, wherein the first level-cell mode of data storage is a single-level cell (SLC) mode of data storage.

14. The memory system of claim 10, wherein the MLC mode of data storage is a triple-level cell (TLC) mode of data storage.

15. The memory system of claim 10, wherein the memory system is structured in an in-vehicle infotainment system.

16. A method of operating a memory system, the method comprising:
directing, within the memory system, data from a first set of logical units of the memory system to one or more buffers of the memory system,
the one or more buffers using a first level-cell mode of data storage; and
directing, within the memory system, data from a second set of logical units of the memory system to a storage area of the memory system by bypassing the one or more buffers, the data from the second set being of a different data type than the data from the first set, the storage area having a multi-level cell (MLC) mode of data storage, the MLC mode of data storage being a higher level storage mode than the first level-cell mode of data storage of the one or more buffers.

17. The method of claim 16, wherein the method includes partitioning one or more memory devices of the memory system to include multiple sets of logical units, each logical unit to hold data of a data type different from data types in other logical units of the partitioned logical units.

18. The method of claim 16, wherein the method includes:
configuring the first set of logical units to a first performance setting; and
configuring the second set of logical units to a second performance setting.

19. The method of claim 16, wherein the method includes flushing data in the one or more buffers to the storage area.

20. The method of claim 16, wherein the first level-cell mode of data storage is a single-level cell (SLC) mode of data storage and the MLC mode of data storage is a triple-level cell (TLC) mode of data storage.
